(19) United States
(12) Patent Application Publication
(10) Pub. No.: US 2024/0254829 A1
(43) Pub. Date: Aug. 1, 2024

(54) DOORS, HALF DOORS, AND METHODS OF MAKING THE SAME

(71) Applicant: Masonite Corporation, Tampa, FL (US)

(72) Inventors: Bei-Hong LIANG, Naperville, IL (US); Jim P. PFAU, Kirkland, IL (US); Steven B. SWARTZMILLER, Batavia, IL (US)

(21) Appl. No.: 18/426,941

(22) Filed: Jan. 30, 2024

Related U.S. Application Data
(60) Provisional application No. 63/441,922, filed on Jan. 30, 2023.

(51) Int. Cl. E06B 3/70

(52) U.S. Cl. CPC E06B 3/7001

(57) ABSTRACT

Doors, half doors, systems and methods of making the same are described, including use of an adhesive that is capable of achieving green strength in a predetermined time, including for exemplary automated embodiments, to prevent movement of the components relative to each other.

### CROSS REFERENCE TO RELATED APPLICATIONS

This application claims priority to U.S. Provisional Application No. 63/441,922, filed Jan. 30, 2023, the disclosure of which is incorporated herein by reference.

### FIELD

The present disclosure relates to doors and half doors, and to methods of making the same.

### BACKGROUND

Solid, natural wood provides aesthetic qualities that are desirable to many consumers and therefore preferred for various products. However, solid, natural wood is a relatively expensive material, and thus products made from solid, natural wood generally are more expensive than products made from alternative materials such as plastics or wood composites. As the price of natural wood has increased, the market for manufactured products that simulate natural wood has grown.

The door market is an example of a market in which natural wood has been replaced with simulated wood and other materials. Assembled doors simulating natural wood doors are well known in the art. Such doors typically include a peripheral frame and two door facings (also known in the art and referred to herein as door skins) respectively secured to opposing surfaces of the frame. The door facings may be formed from wood composite, such as hardboard, medium density fiberboard (MDF), oriented strand board, wood-plastic composites, etc. It is also known to form door facings from sheet molding compounds (SMCs) containing a thermosetting polymer and fiberglass, and from thermoplastic compounds typically reinforced with fiberglass. Steel and other metals are further examples of alternative materials from which the door facings may be made.

The entirety of the exterior surfaces of the door facings may be planar (or “flush”) so as to lie in a single plane. Alternatively, the exterior surfaces of the door facings may include transition regions or contoured regions surrounding panels, which typically are either coplanar with or recessed from the main body area of the door facing surrounding the transition/contoured regions. The main body area of the door facings surrounding the panels and transition regions is often designed with woodgrain patterns arranged perpendicularly to simulate stiles and rails, as found in traditional rail-and-stile solid wood doors. The exterior surface of the door facings may be smooth, or they may be textured, for example, to provide for the appearance of woodgrain and optionally wood background tones.

Typically, the peripheral frame and the door facings define an internal cavity that may include a core. It is desirable for the core to provide rigidity and structural integrity to the door, as well as thermal and acoustic characteristics. To achieve those properties, the core often is made to fill the entire internal cavity. One way of filling the internal cavity with a core is to inject expanding foam through one or more holes drilled in the peripheral frame, and allow the foam to expand and cure.

Another option for filling the internal cavity of the door is to provide a prefabricated solid core. The prefabricated solid cores require machining (e.g., routing) or other shaping of the opposing surfaces of the core to match thickness variations in the internal cavity due to the contours of the transition regions and recessing of the panels of the door facings. The prefabricated solid cores cannot be universally applied to a wide variety of door designs and must be tailored for each door design.

Door assembly in any form presents a number of challenges in order to present a quality product without noticeable defects, which may be caused from a variety of factors, e.g., warping of skins during application of those skins (with warping occurring generally because of temperature or humidity, based on delay of application or inaccurate application of facings, or skins, etc.), general delay during assembly of components, including core components, lack of adhesive bonding or incomplete or delayed bonding between components during assembly, etc.

What is needed in the art are techniques for door manufacturing that alleviate the problems and deficiencies of the prior art.

### SUMMARY

The present disclosure overcomes the problems and disadvantages in the prior art by providing doors and half doors and systems and methods for assembly of doors, wherein the components to be assembled can advantageously be maintained in position, without shifting, as the door being assembled is being transported along the assembly line.

To maintain the position of the components relative to each other, the present disclosure describes use of an adhesive that is capable of quickly achieving green strength (as defined below) to prevent movement of the components relative to each other. The time to achieve green strength may be controlled by the manner in which the adhesive is applied to the door components and also by appropriately selecting the adhesive(s).

In exemplary aspects described herein, systems and methods for assembling doors use particular adhesive properties and particular timings for both laying down adhesive and achieving green strength during assembly.

In further exemplary aspects described herein, automated systems and methods for door assembly include predetermined times for applying adhesive during automated assembly steps, combined with adhesive property aspects determined by the present disclosure to be advantageous for assembly of doors and half doors in order to minimize or to eliminate defects and to ensure quality of construction during such assembly.

In further exemplary aspects, with regard to adhesives, a polyurethane reactive (PUR) adhesive is utilized.

In exemplary aspects, a method of assembling a door includes: applying a first adhesive to a first surface of a frame including first surfaces of plural stiles and rails; assembling the first surface of the frame on a an interior surface of a first door skin to assemble a half door, wherein the first adhesive is a polyurethane reactive (PUR) adhesive configured to achieve green strength within a predetermined time to prevent movement of components relative to one another.

In further exemplary aspects, the first adhesive is roller coated onto the first surface of the frame, or otherwise provided as a film coating. In further exemplary aspects, the first adhesive is spread over the entire first surface of the frame.

In further exemplary aspects the exemplary adhesive has an open time of between one and four minutes. In additional exemplary aspects, the exemplary adhesive has a viscosity of between 7000 and 9500 Centipoise (cP).

In further exemplary aspects, a method includes one or more of coating the first adhesive on the first surface of the frame: at between 0.09 and 0.18 grams per square inch (g/in²); at a temperature between 265 and 285 degrees Fahrenheit; in a time of between about 10 to 15 seconds.

In further exemplary aspects, the assembly of the first surface of the frame to the first skin to form the half door and conveyance of the half door to a press takes 30 to 35 seconds. In additional exemplary aspects, the half door is pressed in a press under pressure for a predetermined period of time for the first adhesive to develop green strength in order to maintain the first skin and the frame in position during further door assembly, e.g., with a press cycle between 20 and 35 seconds, with the press cycle including about 2 to 3 seconds at 98 to 102 pounds per square inch (PSI).

In further exemplary aspects, a second adhesive is applied to an interior surface of a second skin, e.g., to the interior surface of the second skin in areas corresponding to contact points with the frame during assembly of the half door with the second skin, with the assembled half door and the second skin forming a completed door assembly, and wherein the completed door assembly is pressed in a press to allow the second adhesive to achieve green strength for the completed door assembly.

Other exemplary aspects are described below relative to various exemplary steps for assembly of a door, including further adhesive options, application and pressure timings for such steps (e.g., for application of a second door skin), finishing options, core component options, door skin styles and options, etc.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a front perspective view of a an exemplary door in accordance with the present disclosure;

FIG. 2 is a plan view of the exemplary door of FIG. 1 with the first door facing removed;

FIG. 3 is a flow diagram showing exemplary steps in forming the door;

FIG. 4 is a cross-section showing exemplary placement of the frame on the first door facing;

FIG. 5 is a cross-section showing exemplary placement of the second door facing on the door frame; and

FIG. 6 is a photograph of an exemplary frame assembled on the first door skin (having one panel).

### DETAILED DESCRIPTION

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

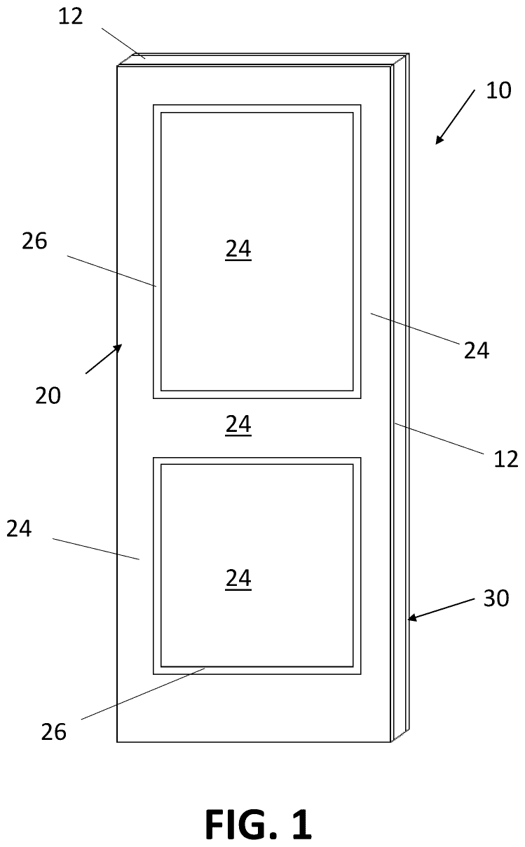

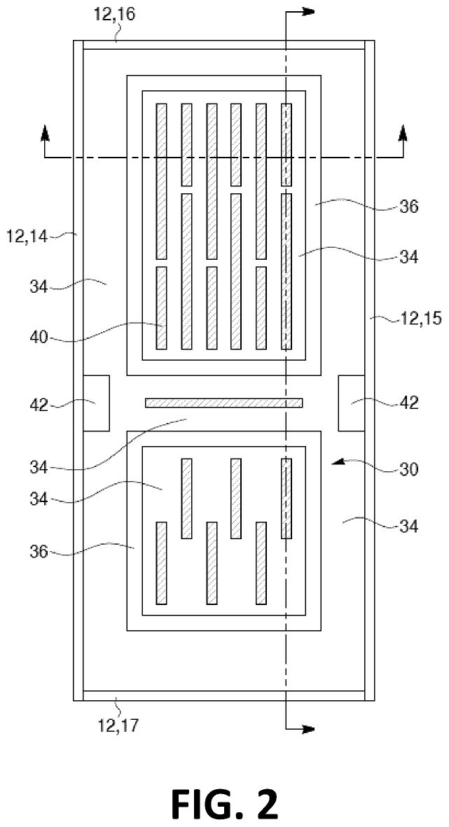

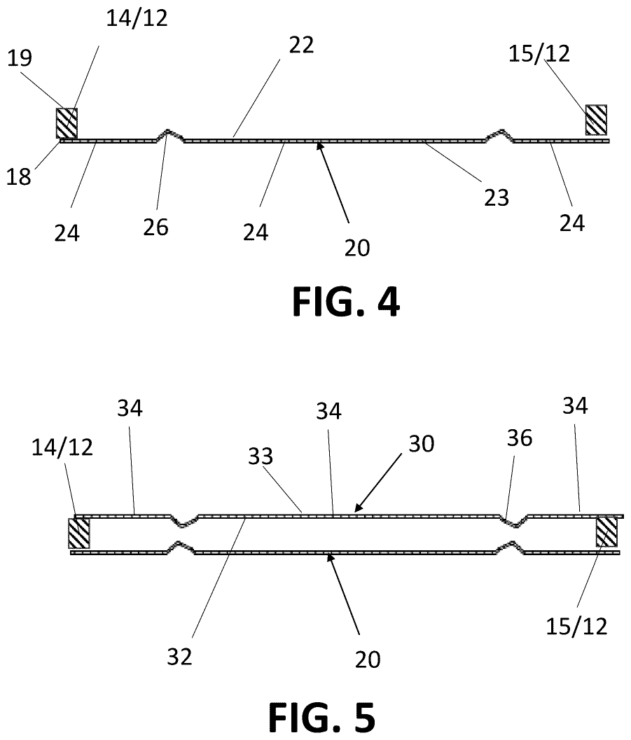

As best shown in FIGS. 1-2, an exemplary door 10 includes a peripheral frame 12. The illustrated exemplary frame 12 includes stiles 14 and 15 (shown in the cross section of FIGS. 4 and 5) and top and bottom rails 16 and 17 (shown in FIG. 2) connecting the ends of the stiles 14 and 15. Although not shown, the frame 12 may include intermediate rails (extending between and parallel to the rails 16 and 17). The frame 12 may also include one or more lock blocks 42. As best shown in FIG. 4, the frame 12 has a first surface 18 and a second surface 19 opposite to the first surface 18. The frame 12 may be made of, for example, wood, metal, composite (e.g., MDF), other materials, or a combination thereof.

The exemplary door 10 further comprises a first door facing 20 and a second door facing 30. The first and second door facings 20 and 30 may be made of, for example, wood composite, fiberglass-reinforced thermoset, such as a sheet molding compound (SMC), fiberglass-reinforced thermoplastic, steel, or other materials. The first and second door facings 20 and 30 are typically made of the same materials and typically are identical to one another, including having the same appearance and thickness.

As best shown in FIG. 4, the exemplary first door facing 20 has a first interior (or interiorly disposed) surface 22 and an opposite first exterior (or exteriorly disposed) surface 23. The first interior surface 22 is secured at its periphery to the first surface 18 of the frame 12. Similarly, as shown in FIG. 5, the second door facing 30 has a second exterior (or exteriorly disposed) surface 33 and an opposite second interior (or interiorly disposed) surface 32. The second interior surface 32 is secured at its periphery to the second surface 19 of the frame 12. The first and second exterior surfaces 23 and 33 face away from (oppose) one another, while the first and second interior surfaces 22 and 32 face toward one another. The exterior surfaces 23, 33 are viewable by a user, and typically are painted, stained, or otherwise decorated for the fashion of the user. The first and second door facings 20 and 30 may be secured to the first and second surfaces 18 and 19 of the frame 12 using adhesive, mechanical fasteners, a combination thereof, or another suitable securing technique. Preferably, adhesive is used to secure the door facings 20 and 30 to the frame 12.

In certain exemplary embodiments, the first and second door facings 20 and 30 may include different regions forming panels in the door. The door 10 shown in FIGS. 1-2 includes paneled door facings 20, 30 having raised regions 24, 34 that are connected by recessed regions 26, 36. Preferably, the door facings 20, 30 are mirror images of each other. The first door facing 20 has raised regions 24 that are coplanar with each other, and recessed regions 26 that are recessed from the raised regions 24. The raised regions 24 form panels. The second door facing 30 is a mirror image of the first door facing 20 and similarly contains its own raised regions 34 and recess regions 36. Overall, the recessed regions 26, 36 of the first and second door facings 20, 30 connect adjacent raised portions 24, 34, respectively.

The raised regions 24, 34 form co-planar panels on the door 10. FIGS. 1-2 show a two-panel door, where a raised region 24, 34 forms a panel with a recessed region 26, 36 surrounds the panel. Although FIGS. 1-2 depict a two-panel door, a skilled person in the art will recognize that doors with other panel configurations, such as one, three, four, five, six, or more panels, may similarly be formed with raised regions 24, 34 forming the panels, while recessed regions 26, 36 surrounding the raised regions 24, 34. Similarly, while the door 10 has raised panels 24, 34, the principles of the invention apply to a door with door facings having recessed panels.

The first and second door facings 20 and 30 of FIGS. 1-2 and 4-5 have identical configurations, as best shown in the cross-sectional views of FIG. 5. The raised region 24, 34 of the first and second door facings 20, 30 are aligned with each other; and the recessed regions 26, 36 of the first and second door facings 20, 30 are aligned with each other.

Although the first and second door facings 20 and 30 are each shown with raised panels, a skilled person in the art would recognize that the panels may be formed with recessed panels, such as that of a shaker door. Each of the door facings 20, 30 may include one or more recessed panels. Moreover, while the panels are shown as being rectangular, those skilled in the art will recognize that they may have any configuration, such as being oval. In certain embodiments, exemplary core insert(s) 40 may be positioned between the first and second door facings 20 and 30, as best shown in FIG. 2.

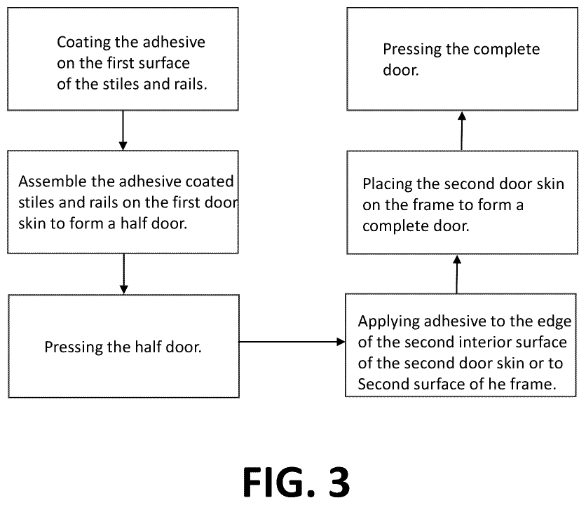

FIG. 3 shows an exemplary process flow chart for assembling the door 10. An adhesive is coated on to the first surfaces 18 of the stiles and rails 16, 17 and stiles 14, 15. The rails 16, 17 and stiles 14, 15 are then assembled on the first door skin 20, such that the first surfaces 18 of the rails 16, 17 and stiles 14, 15 are in contact with the interior surface 22 of the first door skin 20 (see FIG. 4) to assemble a half door. In the half door, the rails 16, 17 and stiles 14, 15 are assembled in their respective positions to form the frame 12. The adhesive is preferably a polyurethane reactive (PUR) adhesive, e.g., available commercially as Rapidex® 4001 or RHM3000 from H.B. Fuller. Preferably the PUR adhesive has an open time of about 1 minute to about 4 minutes and a viscosity of about 7000 to about 9500 Centipoise (cP). The adhesive is preferably roller coated onto the first surfaces 18 of the rails 16, 17 and stiles 14, 15 to form a thin coating of adhesive thereon. Preferably, the adhesive covers the entire first surface 18. The adhesive is a film-like coating on the surfaces 18, and thus is spread over substantially all of the surface 18 to assure maximum coverage. In this way, maximum surface area coverage is achieved to assure good bonding between the frame 12 and surface 22. Preferably, the adhesive coating is applied on the rails 16, 17 and stiles 14, 15 at about 0.09 to about 0.18 g/in² and a temperature of about 265 to about 285° F. The application of the adhesive to the rails 16, 17 and stiles 14, 15 preferably takes about 10 to about 15 seconds; and the assembly of the stiles and rails onto the frame 12 to form the half door and conveyance of the half door to a press preferably take about 30 to about 35 seconds.

In the exemplary process, the half door is then pressed in a press under pressure to allow the frame 12 and first door skin 20 to come in intimate contact with each other, and for a period sufficient to allow the adhesive to develop sufficient green strength to keep the first door skin 20 and frame 12 in position throughout the following assembly process. Green strength is achieved when the adhesive has reached sufficient bonding strength to prevent movement of the door facing(s), frame, and core inserts) relative to each other and to hold the door components together for further handling without adhesive delamination, Preferably, the press cycle is about 20 to about 35 seconds which includes about 2 to about 3 seconds at about 98 to about 102 PSI.

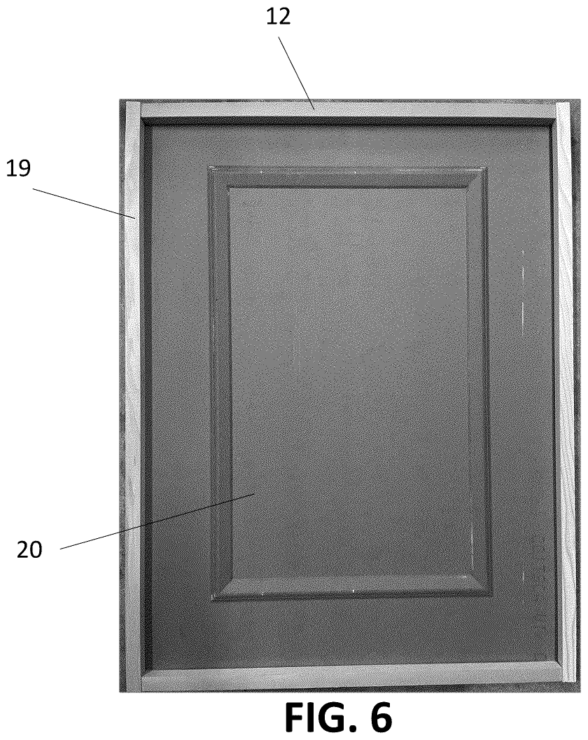

FIG. 6 is an exemplary photograph of a half door having a door skin with one panel. It can be seen that the frame 12 with the stiles and rails is situated at the periphery of the first door facing 20. The exposed second surfaces 19 of the frame 12 are ready for receipt of the second door facing 30.

After pressing, adhesive is applied to the second interior surface 32 of the second door skin 30. If the adhesive is placed on the second interior surface 32, the adhesive preferably is located in areas where the frame 12 comes into contact with the second door skin 30.

As shown in FIG. 5, the second door skin 30 (with the adhesive on the second surface 32 of the frame 12 or on the interior surface of the door skin 30), is then placed onto the second surface 19 of the frame 12. The adhesive adheres the second interior surface 32 of the second door skin 30 to the second surface 19 of the frame 12 to form a complete door.

The complete door assembly is then pressed in a press to allow pressure to be applied to the door 10 to facilitate securing of the frame 12 to the associated door facings. In the press, the adhesive is pressed to achieve sufficient green strength.

After the door 10 has adequately cured, it then may pass through a number of optional finishing operations as needed. For example, the door 10 may be trimmed to size. The door 10 may be passed through a stile and rail trimming station to remove excess material. After the edges have been trimmed, the door may be placed through an edge coating station where the edges of the door 10, such as the exposed rails 16, 17 and stiles 14, 15, are coated or painted. The door 10 may also be subjected to other painting or coating.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to necessarily limit the invention to the precise embodiments disclosed.

We claim:

1. A method of assembling a door, comprising:
applying a first adhesive to a first surface of a frame including first surfaces of plural stiles and rails;
assembling the first surface of the frame on a an interior surface of a first door skin to assemble a half door, wherein the first adhesive is a polyurethane reactive (PUR) adhesive configured to achieve green strength within a predetermined time to prevent movement of components relative to one another.

2. A method in accordance with claim 1, wherein the first adhesive is roller coated onto the first surface of the frame.

3. A method in accordance with claim 1, wherein the first adhesive is provided as a film coating.

4. A method in accordance with claim 1, wherein the first adhesive is spread over the entire first surface of the frame.

5. A method in accordance with claim 1, wherein the first adhesive has an open time of between one and four minutes.

6. A method in accordance with claim 5, wherein the first adhesive has a viscosity of between 7000 and 9500 Centipoise (cP).

7. A method in accordance with claim 6, wherein the first adhesive is coated on the first surface of the frame at between 0.09 and 0.18 grams per square inch (g/in²).

8. A method in accordance with claim 7, wherein the first adhesive is coated on the first surface of the frame at a temperature between 265 and 285 degrees Fahrenheit.

9. A method in accordance with claim 8, wherein the application of first adhesive to the first surface of the frame takes 10 to 15 seconds.

10. A method in accordance with claim 9, wherein the assembly of the first surface of the frame to the first skin to form the half door and conveyance of the half door to a press takes 30 to 35 seconds.

11. A method in accordance with claim 10, wherein the half door is pressed in a press under pressure for a predetermined period of time for the first adhesive to develop green strength in order to maintain the first skin and the frame in position during further door assembly.

12. A method in accordance with claim 11, wherein the press cycle is between 20 and 35 seconds.

13. A method in accordance with claim 11, wherein the press cycle includes 2 to 3 seconds at 98 to 102 pounds per square inch (PSI).

14. A method in accordance with claim 11, wherein a second adhesive is applied to an interior surface of a second skin.

15. A method in accordance with claim 11, wherein the second adhesive is applied to the interior surface of the second skin in areas corresponding to contact points with the frame during assembly of the half door with the second skin.

16. A method in accordance with claim 15, wherein the assembled half door and the second skin form a completed door assembly, and wherein the completed door assembly is pressed in a press to allow the second adhesive to achieve green strength for the completed door assembly.

17. A method in accordance with claim 15, wherein one or both of the first and second adhesives have different assembly and pressing parameters, but share the same green strength properties for the completed, pressed full door assembly.

18. A method in accordance with claim 1, wherein the assembly is an automated assembly.
